(19) United States
(12) Patent Application Publication
(10) Pub. No.: US 2006/0263252 A1
(43) Pub. Date: Nov. 23, 2006

(54) Apparatus and method for chemical and biological agent sensing

(76) Inventors: Jorge Sanchez-Olea, Poway, CA (US); Carol E. Fuller, Lemon Grove, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/545,920

(22) PCT Filed: Feb. 25, 2004
(86) PCT No.: PCT/US04/05627

§ 371 Date: May 16, 2006

Related U.S. Application Data
(60) Provisional application No. 60/450,223, filed on Feb. 25, 2003.

(51) Int. Cl. G01N 21/00

(52) U.S. Cl. 422/82.05

(57) ABSTRACT

The present invention provides an apparatus and method for identification of a chemical or a biological agent using a handheld or portable unit in non-laboratory conditions. More specifically, the system uses a portable unit containing an array of tunable lasers, which are stabilized with a digital controller. The apparatus excites the sample under test with a narrow band light source used to excite fluorescence. The fluorescent response is detected with a broadband detector and digitized. The information is then sent through wireless means to a remote server where a database of appropriate signatures is used to determine the identity of the sample. The results are sent back to the portable unit or to a Personal Digital Assistant (PDA).

### BACKGROUND

1. Field of the Invention

The invention relates to a sensor apparatus and a set of methods used to detect biological agents and chemical compounds using optical methods. The sensing apparatus consists of several electrical and optical elements including a tunable laser, a photodetector, a digital controller and a wireless transmitter. The methods consist of several processes needed to control the sensor including laser wavelength tuning, photodetector control, data conditioning and transmission protocol software.

2. Description of the Related Art

A typical approach used to detect agents or chemicals uses Laser Induced Breakdown Spectroscopy (LIBS). High power laser light is applied to the sample, which is then vaporized into plasma. As the sample is vaporized a broadband spectrum of light is emitted due to multiple electronic transitions. The light is then sent to an optical spectrum analyzer that in turn determines the profile of wavelength versus intensity for the sample analyzed. The spectrum data is then processed by means of digital signal processing (DSP) in a computer in order to filter out noise in the spectrum. Finally, the resultant filtered spectrum is compared with a database of signatures for known biological and chemical agents. Some disadvantages of the LIBS approach are:
1. LIBS destroys the sample in the analysis process since it turns it into plasma
2. Because of the sample destruction the resulting spectrum corresponds to the elements that are part of the sample and not necessarily to the complex molecules that generally form part of an organic molecule.
3. The broad spectrum obtained has a substantial amount of noise because electronic transitions of many atomic energy levels are generated simultaneously. The broad an noisy spectrum requires a significant amount of digital signal processing in order to determine the various chemical compounds present. This situation reduces the reliability of the data obtained.
4. Because of the significant level of DSP and the large signature database required, a computer with significant processing power and memory is needed. This increased the size of the package and requires large batteries to carry the sensor.

FIG. 1(100) illustrates the present methods for sensing agents. The method shown includes the LIBS approach as well as other approaches, which include infrared lighting techniques. A broadband light source (101) is used to generate a light beam (102) and apply light to the unknown agent (103). The materials in the unknown agent (103) absorb the light and in turn react by putting out emitted light (104), which is detected by a detector (105) consisting of an optical spectrum analyzer. The problem with the method is that the emitted light (104) has a wide spectrum (106), which is broadband in nature and also contains a substantial amount of noise because the broadband light source (101) produces electronic transitions in multiple shells in the atoms of the sample at once.

FIG. 2 (200) illustrates an apparatus used to sense the unknown agent (103). The light source (101) and detector (105) are used to capture a wide spectrum (106) from the unknown agent (103). The apparatus contains batteries and a power supply (201). In addition, once the wide spectrum (106) has been obtained, there is the need to carry out Digital Signal Processing using a laptop computer (202). The computer needs to be equipped with a high performance processor in order to carry out all of the mathematical calculations required to execute Digital Signal Processing algorithms. In addition, the laptop computer (202) needs to contain large external disk drives in order to store signature information for known chemical and biological samples. The entire apparatus is large, heavy and very costly.

### SUMMARY OF THE INVENTION

The invention consists of an unknown agent detection methods and an apparatus. The sensing apparatus consists of a sensor and PDA-phone. The method used in this invention is referred to as Laser Induced Spectroscopy. However, in this invention, tunable lasers are used in order to improve results. The sensor contains an array of tunable lasers. A digital controller contained in the sensor controls each laser. The digital controller ensures that the laser emits light in a narrow band of light frequencies. Typical region for analyzing chemical materials and biological agents is in the 300 nanometers to 900 nanometers of light wavelength. Each laser is tuned to a narrow wavelength of light; the amount of laser power is also controlled to a given level. Wavelength and power are set in an appropriate manner so as to obtain a strong emitted spectrum from the unknown agent. Wavelength of the light source is continuously changed from one region of the spectrum to another with an appropriate amount of power in order to detect a strong and reliable spectrum. Each time we change the wavelength and power of the appropriate laser, the detected spectrum is digitized. After the information is digitized, it is sent to a portable Personal Digital Assistant and telephone unit (PDA-phone) for storage. Once an entire sweep of wavelengths and power has been carried out with a corresponding emitted spectrum digitized and stored, the PDA-phone will transmit through wireless means the data to a remote server. The remote server can contain Digital Signal Processing programs used to filter the information. The server can also contain an analysis tool and databases to determine what is the chemical or agent. The server can also connect through the Internet or other means to databases in research laboratories. Once the agent is identified, the system can transmit to the PDA-phone information related to the identity of the agent or instructions on how to proceed if the agent poses a danger to the operator. Arrays of the sensors described ion this invention can be placed in the filed. Data from the array can be collected through wireless means by using a hub. An advantage of the invention is that the detected spectrum (305) will exhibit a high signal to noise ratio. This will increase the reliability of the detection. Another advantage of the invention is that the detection process does not destroy the sample.

Yet another advantage of the invention is that the sensor is portable and exhibits increased accuracy due to the use of databases in remote server (403)

### BRIEF DESCRIPTION OF THE DRAWINGS

Details of the invention, and of the preferred embodiment thereof will be further understood upon reference to the drawings:

FIG. 1 illustrates the present methods for sensing agents.

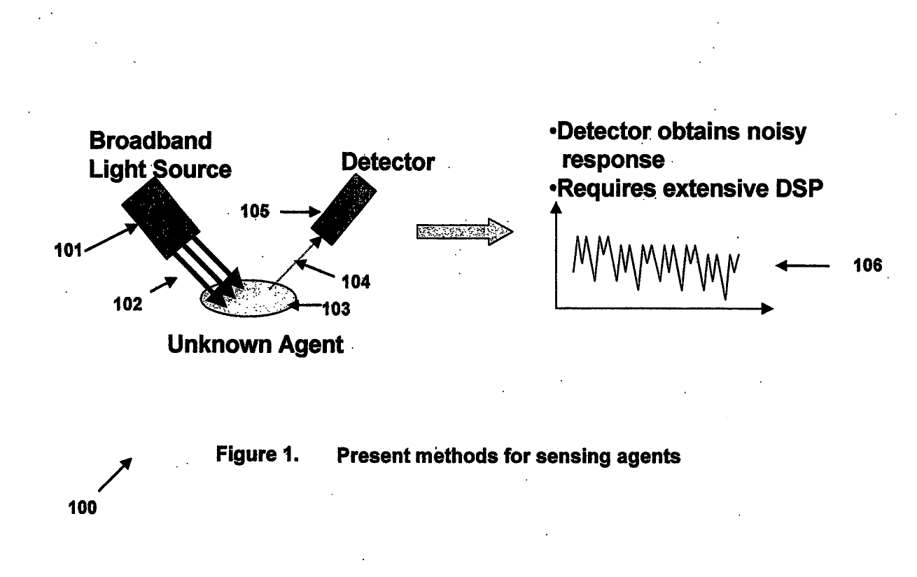

FIG. 2 is an apparatus used for identification of agents with the current methods

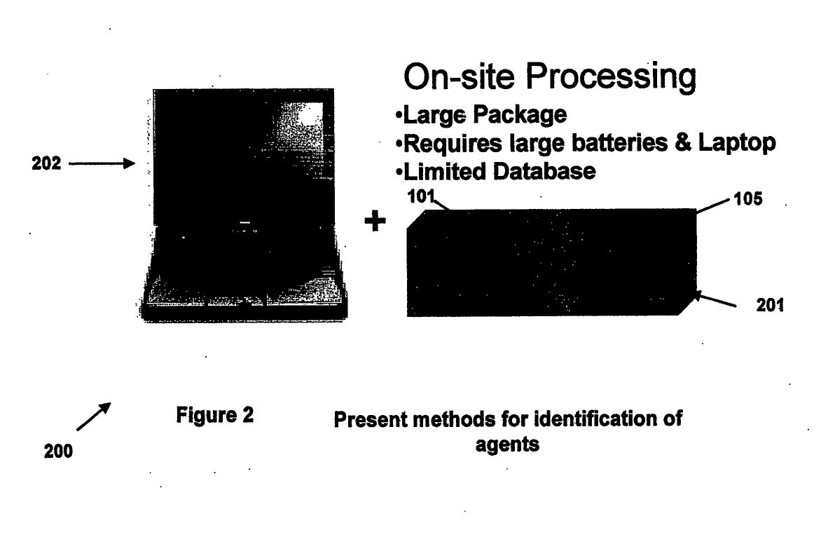

FIG. 3 illustrates the methods used in this invention

FIG. 4 is an apparatus for agent identification used by an embodiment of the present invention.

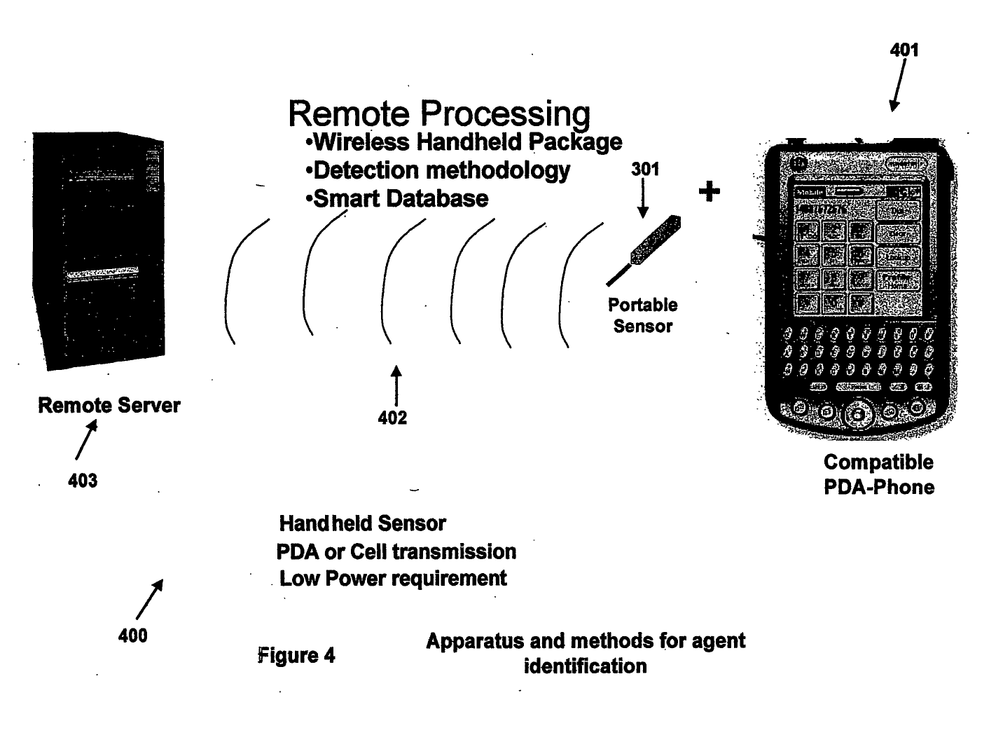

FIG. 5 is a diagram of the portable optical bio-chemical sensor in this invention

### DETAILED DESCRIPTION OF AN EMBODIMENT

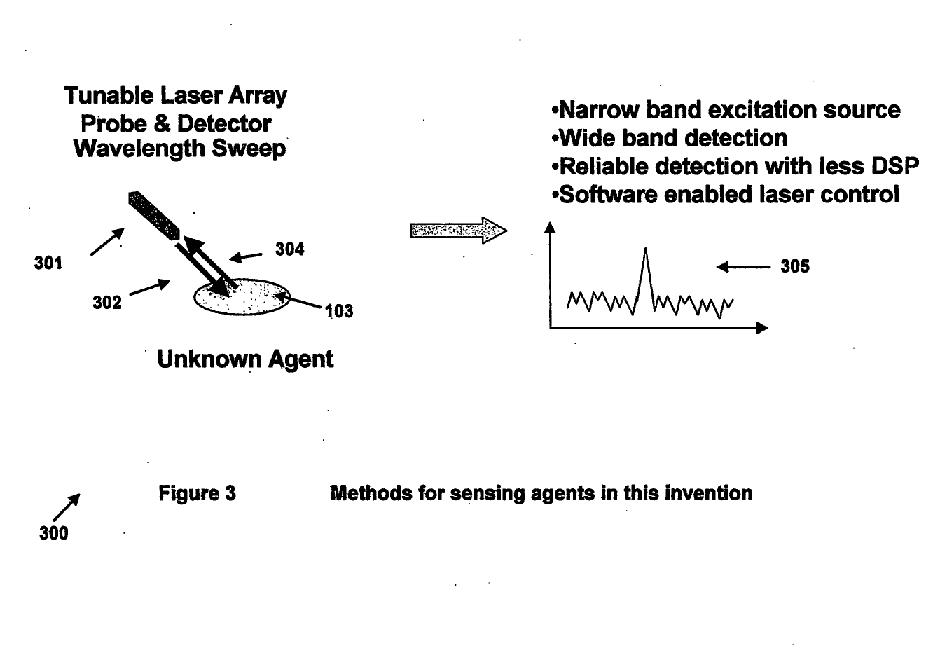

FIG. 3 illustrates the methods for sensing agents in this invention. A portable sensor (301) contains an array of tunable lasers. The portable sensor (301) emits laser light of a narrow spectrum (302). The unknown agent (303) absorbs the laser light (302). Atoms in the unknown agent (303) absorbed the laser light and in turn put out an emitted spectrum of light (304). The spectrum is detected by an internal detector inside of the sensor (301), which stores the information. The sensing process continues with the sensor (301) sweeping through slices of the spectrum of laser light (302) by tuning internal lasers. Each time a different slice of the spectrum is applied to the unknown agent (303), a corresponding emitted spectrum (304) is detected. Because only the response of the unknown agent (303) is detected one slice of spectrum at a time, the detected spectrum (304) will produce an improved response with a lower amount of noise as shown in the graph (305).

Figure (400) shows the entire apparatus and methods for agent identification. Once the emitted spectrum (305) is sensed by the probe (301), information is transferred through the wireless link to a compatible PDA-phone (401). The PDA-phone (401) transfers the sensor information through wireless transmission (402) to a remote server (403). The remote server (403) contains high performance computers and extensive databases to conduct an analysis of the spectrum for the unknown agent (103). The remote server (403) can be connected by alternative means to extensive databases resident in research centers. The remote server performs unknown agent identification using information form the databases. Once the identity of the agent has been established, the server will transmit to the PDA-phone appropriate instructions regarding actions to be taken by the operator or precautions if the agent poses a danger.

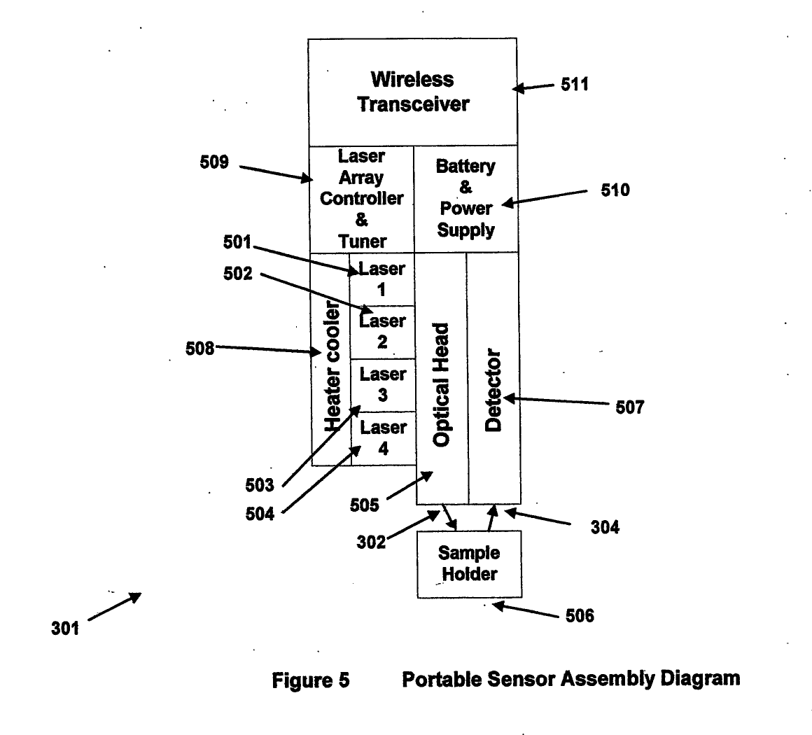

FIG. 5 illustrates a possible embodiment of a portable sensor (301). An array of tunable lasers (501-504) is connected to an optical head (505). Each one of the tunable lasers (501-504) is used to provide narrow band laser light (302). Depending on the unknown agent (103) more lasers than shown in the figure could be required. The optical head (505) collects the light from all lasers (501-504), focuses the light and puts out a beam (302). The beam in turn is applied to a sample folder (506), which contains the unknown agent (103). The emitted spectrum (304) is collected by a detector (507). The detector may be implemented with an optical spectrum analyzer containing a charged coupled device. For some applications, the charged coupled device may be substituted with a simple photodiode detector. The portable sensor (301) also contains a heater cooler (508), which is used to control the temperature of the lasers (501-504). A laser array controller and tuner (509) is used to set the temperature of the heater cooler (508) to the required value in order to produce laser light (501-504) to the correct wavelength. Battery and powers supply (510) are also part of the portable sensor (301). A wireless transceiver (511) is used to send the sensor information to the PDA-phone (401).

1. A system for sensing biological and chemical agents of a sample with a portable sensor, comprising:
one or more tunable lasers;
a controller configured to tune the one or more tunable lasers to one or more wavelengths within a predetermined spectrum of wavelengths, and further configured to control said one or more tunable lasers to provide light to the sample at the one or more wavelengths during a period of time; and
a detector disposed to receive the spectrum of light emitted from the irradiated sample, said detector configured to generate data based on the received light for use in determining sample information on the bio-chemicals of the sample.

2. The system of claim 1, further comprising an optical head disposed to receive light from said one or more tunable lasers and configured to propagate a focused beam of light to the sample.

3. The system of claim 2, further comprising a wavelength tuning element connected to said one or more tunable lasers, said wavelength tuning element configured to receive a signal from said controller and tune the wavelength of said one or more tunable lasers to produce light at the one or more wavelengths during a period of time.

4. The system of claim 3, wherein said wavelength tuning element comprises a temperature control element to control the temperature of the said one or more tunable lasers.

5. The system of claim 1, further comprising a transceiver connected to said detector, said transceiver configured to receive the data from said detector and transmit the data to another location for analysis.

6. The system of claim 1, further comprising an analysis system that receives the data, said analysis system configured to access spectrum identification information, determine sample information using the data and the spectrum identification information, and provide the sample information for determining an action to be taken regarding the sample.

7. The system of claim 5, further comprising a mobile communication device configured to receive the data from said transceiver, store the data, and transmit the data to an analysis system.

8. The system of claim 7, wherein said mobile communication device is further configured to receive the sample information from an analysis system.

9. The system of claim 5, further comprising:
a mobile communication device configured to receive the data from said transceiver, store the data, and transmit the data; and
an analysis system that receives the data from the mobile communication device, said analysis system configured to access spectrum identification information, determine sample information using the data and the spectrum identification information, and provide the sample information for determining an action to be taken regarding the sample.

10. The system of claim 1, wherein said tunable lasers comprise an array.

11. The system of claim 6, wherein said analysis system comprises a computer; and
a chemical compound library or database residing on said computer, wherein said chemical compound library or database comprises spectrum identification information.

12. The system of claim 2, wherein said detector comprises a spectrum analyzer.

13. The system of claim 1, wherein said detector comprises a charge coupled device.

14. The system of claim 1, wherein said detector comprises a photodiode.

15. The system of claim 2, wherein said optical head provides the beam of light to the sample in situ.

16. The system of claim 5, further comprising a power source that supplies power to said transceiver, said controller, said one or more lasers, and said detector.

17. The system of claim 1, wherein said detector collects the light emitted from the sample due to fluorescence of the illuminated sample.

18. A system for sensing biological and chemical agents of a sample with a portable sensor, comprising:
means for illuminating a sample using one or more tunable lasers over a spectrum of wavelengths;
means for receiving light emitted from the illuminated sample; and
means for generating data based on the received light for analysis.

19. The system of claim 18, further comprising means for analyzing the data to determine biological and chemical information relating to the sample.

20. The system of claim 18, further comprising means for transmitting the data to an analysis system to determine sample information.

21. A method of sensing biological and chemical agents of a sample, the method comprising:
providing light from one or more tunable lasers to a sample;
receiving light emitted from the sample resulting from said providing light;
generating data based on the received light; and
analyzing the data to determine bio-chemical information relating to the sample.

22. The method of claim 21, wherein the received light comprises a fluorescence response to the provided light.

23. The method of claim 21, wherein the light is provided to the sample in situ.

24. The method of claim 21, further comprising providing the bio-chemical information to an operator.

25. The method of claim 21, wherein providing light from one or more tunable lasers comprises adjusting a wavelength tuning element.

26. A system for sensing biological and chemical agents of a sample with a portable sensor, comprising:
a plurality of sensors, each sensor comprising
one or more tunable lasers;
a controller configured to tune the one or more tunable lasers to one or more wavelengths within a predetermined spectrum of wavelengths, and further configured to control said one or more tunable lasers to provide light to the sample at the one or more wavelengths during a period of time;
a detector disposed to receive the spectrum of light emitted from the irradiated sample, said detector configured to generate data based on the received light for use in determining sample information on the bio-chemicals of the sample;
a transceiver connected to said detector, said transceiver configured to receive the data from said detector and transmit the data to another location for analysis; and
a communication hub in data communication with the plurality of sensors, said hub configured to receive data from the plurality of sensors and transmit the data to an analysis system to determine sample information.

27. A method of manufacturing a portable sensor for sensing biological and chemical agents of a sample, comprising:
providing one or more tunable lasers;
coupling a controller to said one or more tunable lasers, said controller configured to tune the one or more tunable lasers to one or more wavelengths within a predetermined spectrum of wavelengths, and further configured to control said one or more tunable lasers to provide light to the sample at the one or more wavelengths during a period of time; and
positioning a detector to receive the spectrum of light emitted from the irradiated sample, said detector configured to generate data based on the received light for use in determining sample information on the bio-chemicals of the sample.

28. A portable sensor manufactured by the method of claim 27.
